(19) United States
(12) Patent Application Publication
(10) Pub. No.: US 2024/0288129 A1
(43) Pub. Date: Aug. 29, 2024

(54) METHODS AND INTERNET OF THINGS (IOT) SYSTEMS FOR INTELLIGENT DETECTION OF CATHOSIC PROTECTION IN SMART GAS PIPELINES

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Yuefei WU, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 18/655,302

(22) Filed: May 5, 2024

(30) Foreign Application Priority Data
Mar. 4, 2024 (CN) 202410240175.3

(51) Int. Cl. F17D 5/00; C23F 13/22

(52) U.S. Cl. CPC F17D 5/00; C23F 13/22; C23F 2213/32

(57) ABSTRACT

Disclosed is a method and an Internet of Things (IoT) system for intelligent detection of cathodic protection in a smart gas pipeline. The method may include: obtaining pipeline potential data of a first preset point; obtaining environmental detection data of a second preset point; determining, based on the environmental detection data, a device corrosion degree of the first preset point; obtaining a soil resistivity of a third preset point; determining, based on the soil resistivity, a resistance distribution; obtaining pipeline data and cathodic protection data; determining, based on the pipeline data and the cathodic protection data, an IR drop distribution; determining a cathodic protection effect based on the device corrosion degree, the resistance distribution, the IR drop distribution, and the pipeline potential data; and in response to determining that the cathodic protection effect does not meet a preset condition, issuing an early warning prompt.

### CROSS-REFERENCE TO RELATED APPLICATIONS

This application priority to Chinese Patent Application No. 202410240175.3, filed on Mar. 4, 2024, the entire contents of which are hereby incorporated by reference.

### TECHNICAL FIELD

The present disclosure relates to the field of pipeline cathodic protection detection, and in particular, to a method and an Internet of Things (IoT) system for intelligent detection of cathodic protection in a smart gas pipeline.

### BACKGROUND

As a gas pipeline network operates, safety issues such as corrosion inevitably arise in a gas pipeline. Forced current cathodic protection is a main measure for corrosion prevention of a buried pipeline, and maintenance and management of cathodic protection are crucial. A pipeline-to-ground potential is an important parameter for evaluating an operation situation of a cathodic protection system of the pipeline, and it is necessary to test a pipeline-to-ground potential to determine a status of cathodic protection.

CN104651853A discloses a device and a method for detection of cathodic protection, which measures a depolarization potential of a pipeline by disconnecting a power supply of the cathodic protection system, wherein the depolarization potential is the same as a pipeline polarization potential, i.e., a pipeline-to-ground potential. The method requires no interference of a stray current at a test point and necessitates use of a highly responsive automatic recorder. However, due to different sizes of defects in a pipeline coating, polarization levels are inconsistent, resulting in a residual I (current) R (resistance) drop component. In addition, due to the influence of the stray current on the buried pipeline, the IR drop is more difficult to eliminate, thereby causing distortion in measuring the pipeline-to-ground potential and affecting an effectiveness of the cathodic protection system.

Therefore, a method and an Internet of Things (IoT) system for intelligent detection of cathodic protection in a smart gas pipeline are provided, which are beneficial for ensuring the effectiveness of the cathodic protection system.

### SUMMARY

One or more embodiments of the present disclosure provide a method for intelligent detection of cathodic protection in a smart gas pipeline. The method may be executed by a smart gas pipeline network safety management platform of an Internet of Things (IoT) system for intelligent detection of cathodic protection in the smart gas pipeline, and the method may include: obtaining pipeline potential data of a first preset point; obtaining environmental detection data of a second preset point; determining, based on the environmental detection data, a device corrosion degree of the first preset point, the second preset point being determined based on the first preset point; obtaining a soil resistivity of a third preset point; determining, based on the soil resistivity, a resistance distribution, the third preset point being determined based on the first preset point; obtaining pipeline data and cathodic protection data; determining, based on the pipeline data and the cathodic protection data, an IR drop distribution; determining a cathodic protection effect based on the device corrosion degree, the resistance distribution, the IR drop distribution, and the pipeline potential data; and in response to determining that the cathodic protection effect does not meet a preset condition, issuing an early warning prompt.

One or more embodiments of the present disclosure provide an Internet of Things (IoT) system for intelligent detection of cathodic protection in a smart gas pipeline. The system may include a smart gas pipeline network safety management platform, and the smart gas pipeline network safety management platform may be configured to: obtain pipeline potential data of a first preset point; obtain environmental detection data of a second preset point; determine, based on the environmental detection data, a device corrosion degree of the first preset point, the second preset point being determined based on the first preset point; obtain a soil resistivity of a third preset point; determine, based on the soil resistivity, a resistance distribution, the third preset point being determined based on the first preset point; obtain pipeline data and cathodic protection data; determine, based on the pipeline data and the cathodic protection data, an IR drop distribution; determine a cathodic protection effect based on the device corrosion degree, the resistance distribution, the IR drop distribution, and the pipeline potential data; and in response to determining that the cathodic protection effect does not meet a preset condition, issue an early warning prompt.

One or more embodiments of the present disclosure provide a non-transitory computer-readable storage medium, wherein the storage medium stores one or more sets of computer instructions. When a computer reads the one or more sets of computer instructions in the storage medium, the computer executes the method for intelligent detection of cathodic protection in the smart gas pipeline as described in the embodiments of the present disclosure.

### BRIEF DESCRIPTION OF THE DRAWINGS

The present disclosure is further illustrated by way of exemplary embodiments, which are described in detail through the accompanying drawings. These embodiments are not limiting, and in these embodiments, a same numbering indicates a same structure, wherein:

FIG. 1 is a schematic diagram illustrating an Internet of Things (IoT) system for intelligent detection of cathodic protection in a smart gas pipeline according to some embodiments of the present disclosure;

FIG. 2 is a flowchart illustrating an exemplary process of a method for intelligent detection of cathodic protection in a smart gas pipeline according to some embodiments of the present disclosure;

FIG. 3 is a flowchart illustrating an exemplary process of predicting a device corrosion degree according to some embodiments of the present disclosure;

FIG. 4 is a schematic diagram illustrating a soil resistivity distribution according to some embodiments of the present disclosure; and

FIG. 5 is a flowchart illustrating an exemplary process of issuing an early warning prompt according to some embodiments of the present disclosure.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “an,” and/or “the” do not refer specifically to the singular but may also include the plural. In general, the terms “include,” “includes,” “including,” “comprise,” “comprising,” and/or “comprises” suggest only the inclusion of clearly identified steps and elements, which do not constitute an exclusive list, and the method or device may also include other steps or elements.

The present disclosure uses flowcharts to illustrate the operations performed by the system according to some embodiments of the present disclosure. It should be understood that the operations described herein are not necessarily executed in a specific order. Instead, they may be executed in reverse order or simultaneously. Additionally, other operations may be added to these processes or certain operations may be removed.

A pipeline-to-ground potential is an important parameter for evaluating an operation situation of a cathodic protection system for a pipeline, but a measurement of the pipeline-to-ground potential is distorted when the pipeline-to-ground potential is affected by an IR drop. CN104651853A measures a pipeline polarization potential, i.e., the pipeline-to-ground potential, by measuring a depolarization potential. However, when affected by a stray current or the like, the measured depolarization potential still includes an IR drop component, affecting an effectiveness of the cathodic protection system. Therefore, in some embodiments of the present disclosure, a cathodic protection effect is determined based on a device corrosion degree, a resistance distribution, an IR drop distribution, and pipeline potential data, and in response to determining that the cathodic protection effect does not meet a preset condition, an early warning prompt is issued. The device corrosion degree is a factor reflecting the cathodic protection effect, and the better the cathodic protection effect is, the lower the device corrosion degree is. The resistance distribution and the IR drop distribution are factors affecting an accuracy of pipeline potential measurement. If a soil resistance at a measurement point is greater, the IR drop is also greater, making pipeline potential data at the measurement point more unreliable, and even necessitating the elimination of corresponding pipeline potential data when assessing the cathodic protection effect in the future. Therefore, in some embodiments of the present disclosure, by analyzing the factors affecting the accuracy of the pipeline potential measurement, it is helpful to assess the effectiveness of the cathodic protection system using more accurate pipeline potential data, and then analyze the pipeline potential data in conjunction with the factors that manifest the cathodic protection effect, thereby further achieving an accurate assessment and ensuring the effectiveness of the cathodic protection system.

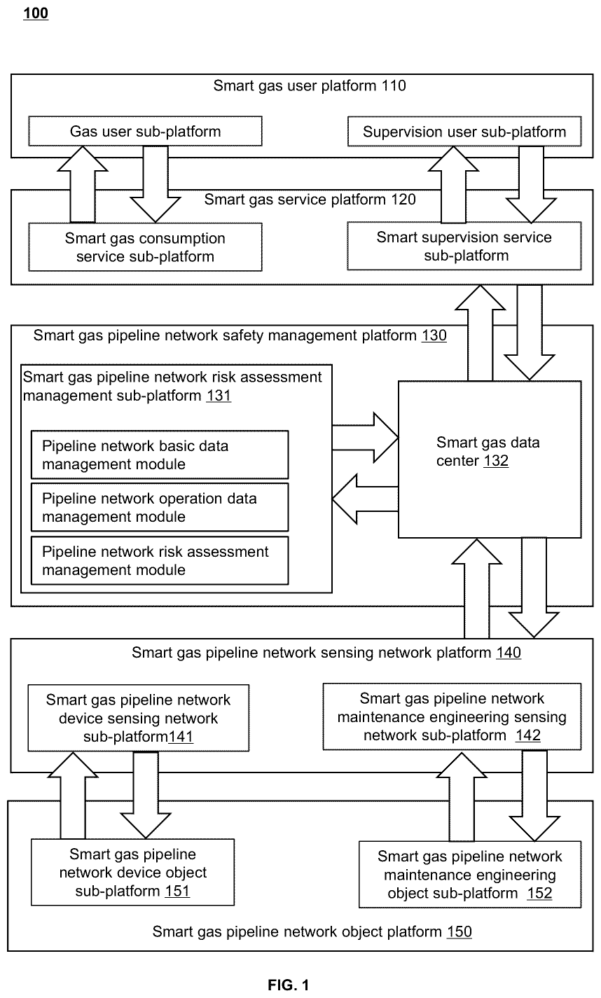

FIG. 1 is a schematic diagram illustrating an Internet of Things (IoT) system for intelligent detection of cathodic protection in a smart gas pipeline according to some embodiments of the present disclosure.

As shown in FIG. 1, an IoT system 100 for intelligent detection of cathodic protection in a smart gas pipeline includes a smart gas user platform 110, a smart gas service platform 120, a smart gas pipeline network safety management platform 130, a smart gas pipeline network sensing network platform 140, and a smart gas pipeline network object platform 150.

The smart gas user platform 110 refers to a platform for interacting with a user. In some embodiments, the smart gas user platform 110 may be configured as a terminal device.

In some embodiments, the smart gas user platform 110 may include a gas user sub-platform and a supervisory user sub-platform.

The gas user sub-platform is a platform that provides a gas user with data related to a gas usage and a solution to a gas problem. The gas user may be an industrial gas user, a commercial gas user, a general gas user, etc.

The supervisory user sub-platform is a platform where a supervisory user supervises an operation of the entire IoT system. The supervisory user is a person in a safety management department.

In some embodiments, the smart gas user platform 110 may push a protection solution for a gas pipeline to a user based on the gas user sub-platform. The smart gas user platform 110 may obtain pipeline network safety risk reminder information and a strategy for pipeline network maintenance, inspection, and troubleshooting based on the supervisory user sub-platform, and send the pipeline network safety risk reminder information and the strategy for pipeline network maintenance, inspection, and troubleshooting to the supervisory user.

The smart gas service platform 120 is a platform configured to communicate the user's demand and control information. The smart gas service platform 120 may receive the protection solution for the gas pipeline uploaded by the smart gas pipeline network safety management platform 130 and upload the protection solution to the smart gas user platform 110.

In some embodiments, the smart gas service platform 120 may include a smart gas consumption service sub-platform and a smart supervision service sub-platform.

The smart gas service sub-platform is a platform that provides the gas user with a gas service.

The smart supervisory service sub-platform is a platform that provides a supervisory need for the supervisory user.

The smart gas pipeline network safety management platform 130 is a platform that coordinates and harmonizes connections and collaborations between various functional platforms, aggregates all information of the IoT system, and provides perception management and control management functions for the operation of the IoT system.

In some embodiments, the smart gas pipeline network safety management platform 130 may include a smart gas pipeline network risk assessment management sub-platform 131 and a smart gas data center 132.

The smart gas pipeline network risk assessment management sub-platform 131 may be configured to form a pipeline network safety risk assessment based on a preset model, combined with network basic data and operational data of the pipeline. The smart gas pipeline network risk assessment management sub-platform 131 may carry out safety risk grading based on the assessment and Geographic Information System (GIS) for three-dimensional visualization management with different color differentiations. In some embodiments, the smart gas pipeline network risk assessment management sub-platform 131 may include, but is not limited to, a pipeline network basic data management module, a pipeline network operation data management module, and a pipeline network risk assessment management module. The smart gas pipeline network risk assessment management sub-platform 131 may be configured to analyze and process data related to pipeline network monitoring through the aforementioned management modules.

The smart gas data center 132 may be configured to store and manage all operational information of the IoT system 100 for intelligent detection of cathodic protection in the smart gas pipeline. In some embodiments, the smart gas data center 132 may be configured as a storage device for storing data related to pipeline network monitoring, etc.

In some embodiments, the smart gas pipeline network safety management platform 130 may interact with the smart gas service platform 120 and the smart gas pipeline network sensing network platform 140, respectively, through the smart gas data center 132. For example, the smart gas data center 132 may send the pipeline network safety risk reminder information and the gas pipeline protection solution to the smart gas service platform 120. As another example, the smart gas data center 132 may send an instruction to obtain data related to the pipeline network monitoring to the smart gas pipeline network sensing network platform 140, thereby obtaining the data related to the pipeline network monitoring.

The smart gas pipeline network sensing network platform 140 is a functional platform that manages sensing communication. In some embodiments, the smart gas pipeline network sensing network platform 140 may perform functions of sensing communication for sensing information and sensing communication for controlling information.

In some embodiments, the smart gas pipeline network sensing network platform 140 may include a smart gas pipeline network device sensing network sub-platform 141 and a smart gas pipeline network maintenance engineering sensing network sub-platform 142. The smart gas pipeline network device sensing network sub-platform 141 and the smart gas pipeline network maintenance engineering sensing network sub-platform 142 may be configured to obtain operation information of a gas pipeline network device and operation information of gas pipeline network maintenance engineering, respectively.

The smart gas pipeline network object platform 150 is a functional platform for sensing information generation and controlling information execution. For example, the smart gas pipeline network object platform 150 may monitor and generate the operation information of the gas pipeline network device and the operation information of the gas pipeline network maintenance engineering.

In some embodiments, the smart gas pipeline network object platform 150 may include a smart gas pipeline network device object sub-platform 151 and a smart gas pipeline network maintenance engineering object sub-platform 152.

In some embodiments, the smart gas pipeline network device object sub-platform 151 may be configured as various types of gas pipeline network devices and monitoring devices.

In some embodiments, the smart gas pipeline network safety management platform 130 may form the strategy for pipeline network maintenance, inspection, and troubleshooting based on the pipeline network safety risk assessment, and through the smart gas pipeline network sensing network platform 140, conduct remote scheduling management for the smart gas pipeline network maintenance engineering object sub-platform 152 to ensure a safety operation of the pipeline network.

In some embodiments of the present disclosure, based on the Internet of Things (IoT) system 100 for intelligent detection of cathodic protection in the smart gas pipeline, a closed loop of information operation between the smart gas pipeline network object platform 150 and the smart gas user platform 110 may be formed. Under unified management of the smart gas pipeline safety management platform 130, coordination and regulated operations are achieved, realizing informatization and intelligence of gas data and gas protection management.

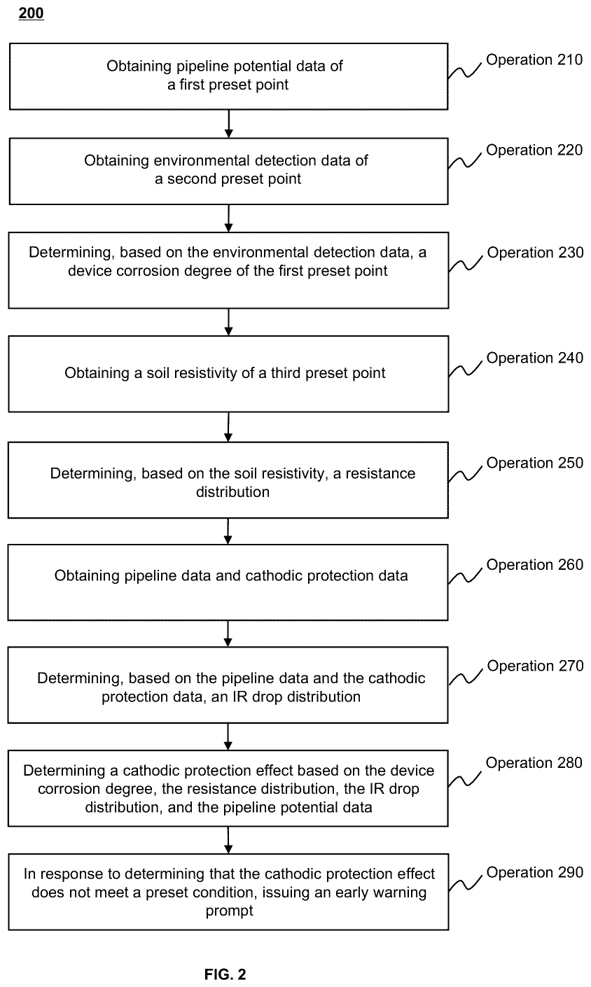

FIG. 2 is a flowchart illustrating an exemplary process of a method for intelligent detection of cathodic protection in a smart gas pipeline according to some embodiments of the present disclosure. In some embodiments, process 200 may be performed by the smart gas pipeline network safety management platform 130. As shown in FIG. 2, process 200 includes following operations.

Operation 210, obtaining pipeline potential data of a first preset point.

The first preset point refers to a measurement point where pipeline potential data is measured. For example, the first preset point may be a plurality of measurement points where potentials above or to a side of an outer wall of a pipeline are measured.

In some embodiments, the pipeline potential data refers to potential data associated with cathodic protection of a gas pipeline. For example, the pipeline potential data may be a potential difference between the gas pipeline and ground, and the potential difference may be expressed in millivolts (mV).

In some embodiments, the pipeline potential data may be collected by a potential detection device. The potential detection device may include a remote potentiometer. The smart gas pipeline network safety management platform 130 may be configured to obtain the pipeline potential data via the smart gas pipeline network sensing network platform 140 based on the smart gas pipeline network object platform 150.

Operation 220, obtaining environmental detection data of a second preset point.

In some embodiments, the second preset point refers to a measurement point where the environmental detection data is measured. The second preset point is determined based on the first preset point. For example, the smart gas pipeline network safety management platform 130 may predetermine a set of points around each of the first preset points as the second preset points, wherein the set of points includes a plurality of points. That is, one first preset point corresponds to a plurality of second preset points.

The environmental detection data refers to data obtained by collecting various indicators in an environment. For example, the environmental detection data may include one or more of a temperature, a humidity, a pH value, an oxygen content, a moisture content, a sulfide content, and a chloride content of soil.

In some embodiments, the environmental detection data may be collected by an environmental detection device. The environmental detection device may include various detection instruments, such as a temperature sensor, a humidity sensor, a pH sensor, an oxygen sensor, a soil moisture sensor, a sulfur ion selective electrode, a chloride ion selective electrode, or the like. The smart gas pipeline network safety management platform 130 may be configured to obtain the environmental detection data via the smart gas pipeline network sensing network platform 140 based on the smart gas pipeline network object platform 150.

Operation 230, determining, based on the environmental detection data, a device corrosion degree of the first preset point.

In some embodiments, the device corrosion degree refers to a degree of corrosion on a surface of a device. For example, the device corrosion degree may be a depth, a rate, or an area of corrosion on the surface of the device. The device may include a potential detection device.

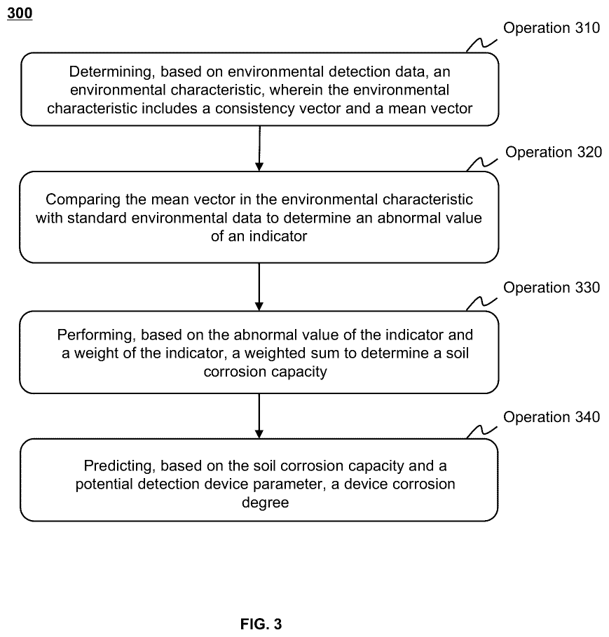

In some embodiments, the smart gas pipeline network safety management platform 130 may be configured to analyze the environmental detection data, obtain an environmental characteristic and a soil corrosion capacity, and predict the device corrosion degree at the first preset point. More descriptions regarding predicting the device corrosion degree may be found in FIG. 3 and the related descriptions thereof.

Operation 240, obtaining a soil resistivity of a third preset point.

In some embodiments, the third preset point refers to a measurement point where the soil resistivity is measured. The third preset point includes a first type of point and a second type of point. The first type of point is determined based on the first preset point. For example, a set of points is preset around each of the first preset points as the third preset points, that is, one first preset point corresponds to a plurality of third preset points. The third preset points and the second preset points may have an overlapping portion. The second type of point is determined based on a gas pipeline location, for example, the smart gas pipeline network safety management platform 130 may preset a set of points as the third preset points at a gas pipeline location in a region not covered by the first preset point.

In some embodiments, the soil resistivity is an indicator characterizing a soil electrical conductivity. The soil resistivity may change under different conditions, e.g., the soil resistivity may change under different soil types, water contents, temperatures, salinities, and soil structures.

A change in the soil resistivity may affect a result of a potential measurement. For example, an increase in the soil resistivity leads to attenuation of a potential signal, and a relatively large amplitude of attenuation of the potential signal results in an inaccurate potential measurement. The increase in the soil resistivity results in a distortion of the potential signal, and a distorted potential signal may not accurately reflect an actual potential distribution. The change in the soil resistivity creates a potential difference between soil electrodes, affecting the accuracy of the potential measurement. Increased soil resistivity provides strong shielding against an underground interference signal, potentially reducing the interference signal in the potential measurement.

Therefore, the smart gas pipeline network safety management platform 130 may take the soil resistivity into account when performing the potential measurement and take some measures to minimize the influence of the soil resistivity on a measurement result. For example, the smart gas pipeline network safety management platform 130 may adopt an appropriate electrode arrangement and distance to minimize the attenuation of the potential signal. The smart gas pipeline network safety management platform 130 may also adopt a correction technique to correct for an effect of the potential difference and potential distortion. In addition, the smart gas pipeline network safety management platform 130 may select an appropriate potential measurement device and a parameter to obtain an accurate measurement result.

In some embodiments, the soil resistivity of the third preset point is collected and obtained by a resistance detection device. For example, the resistivity detection device may include a resistivity sensor.

Operation 250, determining, based on the soil resistivity, a resistance distribution.

In some embodiments, the resistance distribution refers to a distribution of resistance values in a space. For example, the resistance distribution may be a distribution of resistance in soil at different locations. The resistance distribution may be represented by a heat map, a three-dimensional graph, or the like.

In some embodiments, the smart gas pipeline network safety management platform 130 may be configured to process and analyze the soil resistivity to determine the resistance distribution.

Operation 260, obtaining pipeline data and cathodic protection data.

In some embodiments, the pipeline data refers to various information and parameters associated with a pipeline system. For example, the pipeline data may include material information, dimensional information, geometric information, construction and installation information, and device and accessory data of pipelines at different locations.

The material information may include a type of material used for the pipeline, such as iron, plastic, stainless steel, etc. The material information may also include a grade number, a specification, and a chemical composition of a corresponding material. The dimensional information of the pipeline may include a diameter, a length, a wall thickness, and other dimensional parameters of the pipeline. The geometric information of the pipeline may include a shape of the pipeline, such as a round pipeline, a square pipeline, or the like. The geometric information of the pipeline may also include a geometric characteristic such as a bend angle, a bend radius, or the like. The construction and installation information may include a way in which the pipeline is installed, e.g., installed overhead, buried, etc., a connection manner of the pipeline, e.g., welded, threaded, flanged, etc., and a construction record. The device and accessory data of the pipeline refers to types of a device and an accessory on the pipeline and related information thereof, such as a specification, a model, and installation information for a valve, a flange, a bracket, or the like.

In some embodiments, the cathodic protection data refers to various information and parameters used to assess and monitor the effectiveness of a cathodic protection system. For example, the cathodic protection data may include a magnitude of a cathodic protection current and a current distribution in different protection regions.

The magnitude of the cathodic protection current refers to a magnitude of a current supplied by a power supply for cathodic protection at a cathodic protection station. The current distribution in different protection regions refers to magnitudes of the currents allocated by a current distribution device at the cathodic protection station to each preset protection region. The preset protection region is divided by a technician based on a distribution of gas pipelines in the protection region. The preset protection region may include one or more pipeline branches or may be part of a pipeline branch.

In some embodiments, the smart gas pipeline network safety management platform 130 may obtain the pipeline data through a design document and a drawing of the pipeline. In some embodiments, the smart gas pipeline network safety management platform 130 may obtain the cathodic protection data via the potential detection device.

Operation 270, determining, based on the pipeline data and the cathodic protection data, an IR drop distribution.

In some embodiments, an IR drop is a resistive voltage drop generated by a flow of a current through a medium. In measuring a pipeline-to-ground potential, the IR drop may be a test obstacle for some instruments, resulting in a reading deviation, so the IR drop should be removed. The IR drop is a combination of parameters including I (current) and R (resistance) and typically ranges from tens of millivolts to several hundred millivolts.

In some embodiments, the IR drop distribution refers to a distribution of IR drops in different regions. For example, the IR drop distribution may represent a distribution of IR drops in the pipeline corresponding to a plurality of first preset points.

In some embodiments, the smart gas pipeline network safety management platform 130 may determine the IR drop distribution based on the pipeline data and the cathodic protection data, which may include the following operations:

In a first operation, a pipeline resistance distribution vector may be determined based on the pipeline data through a preset correspondence.

The preset correspondence refers to a correspondence between the pipeline data and a pipeline resistance, wherein the pipeline data may include the material information, the dimensional information, the geometric information, the construction and installation information, and the device and accessory data of pipelines in different pipeline regions.

The pipeline resistance distribution vector refers to a vector characterizing a distribution of resistances in different pipeline regions. The smart gas pipeline network safety management platform 130 may divide each pipeline region into a plurality of subregions of a preset length, determine a pipeline resistance of each subregion based on the preset correspondence, and construct the pipeline resistance vector based on pipeline resistances of the plurality of subregions in a pipeline region.

In some embodiments, the smart gas pipeline network safety management platform 130 may process vectors based on a clustering algorithm to determine at least one clustering center. The at least one clustering center represents a mean value of the pipeline resistances of the plurality of subregions. The smart gas pipeline network safety management platform 130 may designate the at least one clustering center as the pipeline resistance of the pipeline region and construct the pipeline resistance distribution vector based on the pipeline resistances of the different pipeline regions, wherein elements of the pipeline resistance distribution vector may correspond to the pipe resistances of the different pipeline regions.

In a second operation, a pipeline current distribution vector may be determined based on the current distribution in different protection regions.

The pipeline current distribution vector refers to a vector reflecting the current distribution in the different pipeline regions. The smart gas pipeline network safety management platform 130 may designate a current of a preset protection region in which a pipeline region is located as the current of the pipeline region. When a pipeline region is located in two or more different preset protection regions at the same time, the pipeline region may be divided into two or more new pipeline regions based on the two or more different preset protection regions. The smart gas pipeline network safety management platform 130 may construct the pipeline current distribution vector based on currents of the different pipeline regions, and elements of the pipeline current distribution vector may correspond to the currents of the different pipeline regions.

In a third operation, the IR drop distribution may be determined based on the pipeline resistance distribution vector and the pipeline current distribution vector.

The IR drop distribution refers to pipeline IR drop distributions corresponding to a plurality of first preset points. In some embodiments, the smart gas pipeline network safety management platform 130 may determine, for each of the plurality of first preset points, the pipeline IR drop distribution based on the pipeline resistance distribution vector and the pipeline current distribution vector.

In some embodiments, the IR drop of a pipeline region is positively correlated with a current in the pipeline region in the pipeline current distribution and a resistance in the pipeline region in the pipeline resistance distribution. For example, for each pipeline region upstream of the preset point, the IR drop of the pipeline region may be obtained by equation (1):

$$Z = I \times R \qquad ( 1 )$$

wherein Z denotes the IR drop of the pipeline region, I denotes the current of the pipeline region in the pipeline current distribution, and R denotes the resistance of the pipeline region in the pipeline resistance distribution. The smart gas pipeline network safety management platform 130 may sum the IR drop of each pipeline region upstream of a preset point as the pipeline IR drop corresponding to the preset point, wherein a gas pipeline upstream of the preset point refers to a gas pipeline through which gas flows earlier than the preset point during gas transportation.

Operation 280, determining a cathodic protection effect based on the device corrosion degree, the resistance distribution, the IR drop distribution, and the pipeline potential data.

In some embodiments, the cathodic protection effect refers to a degree and effect of cathodic protection on a pipeline surface under the cathodic protection system. The cathodic protection effect may be expressed by a numerical value such as a grade, a percentage, or the like. For example, the higher the percentage is, the better the cathodic protection effect is.

In some embodiments, the smart gas pipeline network safety management platform 130 may select credible pipeline potential data based on the device corrosion degree, the resistance distribution, and the IR drop distribution. The credible pipeline potential data refers to corresponding pipeline potential data when an influence of the device corrosion degree, the soil resistance, and the pipeline IR drop is minimal.

In some embodiments, the smart gas pipeline network safety management platform 130 may determine a credibility degree of the pipeline potential data by performing a weighted sum on the device corrosion degree, the soil resistance, and the IR drop, and selecting the pipeline potential data with a credibility degree higher than a preset threshold as the credible pipeline potential data.

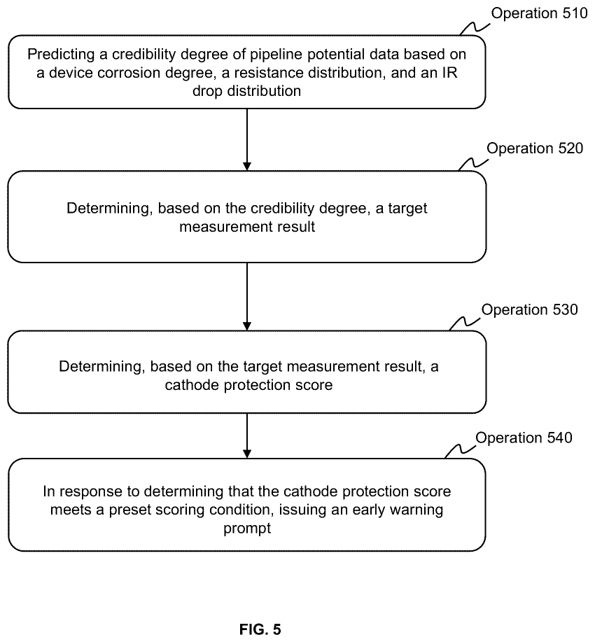

The smart gas pipeline network safety management platform 130 may further evaluate the cathodic protection effect using the selected credible pipeline potential data. For example, the intelligent gas network safety management platform 130 may determine the cathodic protection effect by querying a first preset table based on the credibility degree of the pipeline potential data. The first preset table may be established based on the credibility degree of the pipeline potential data, a difference between the pipeline potential data and standard pipeline potential data, and the cathodic protection effect. More descriptions regarding the cathodic protection effect may be found in FIG. 5 and the related descriptions thereof.

Operation 290, in response to determining that the cathodic protection effect does not meet a preset condition, issuing an early warning prompt.

In some embodiments, the preset condition refers to a baseline condition where the cathodic protection effect prevents pipeline corrosion based on the pipeline potential data. For example, when the cathodic protection effect falls below a preset protective threshold, the early warning prompt may be issued.

In some embodiments, the early warning prompt may include a safety risk reminder message, a corresponding warning pipeline location, and a strategy for pipeline network maintenance, inspection, and troubleshooting.

In some embodiments, the smart gas pipeline network safety management platform 130 sends the early warning prompt via the smart gas pipeline network maintenance engineering sensing network sub-platform 142 to the smart gas pipeline network maintenance engineering object sub-platform 152. The smart gas pipeline network safety management platform 130 may also send the early warning prompt to the smart gas user platform 110 via the smart gas service platform 120.

In some embodiments of the present disclosure, the smart gas pipeline network safety management platform 130, based on the device corrosion degree, the resistance distribution, and the IR drop distribution, takes into account factors affecting the cathodic protection effect and factors affecting the accuracy of the pipeline potential measurement, and selects the effective pipeline potential data to determine the cathodic protection effect, which improves the accuracy of the pipeline potential and realizes more effective assessment of the effectiveness of the cathodic protection system, thereby further safeguarding the effectiveness of the cathodic protection system.

FIG. 3 is a flowchart illustrating an exemplary process of predicting a device corrosion degree according to some embodiments of the present disclosure. In some embodiments, process 300 may be performed by the smart gas pipeline network safety management platform 130. As shown in FIG. 3, process 300 includes the following operations.

Operation 310, determining, based on the environmental detection data, an environmental characteristic.

The environmental characteristic refers to a vector extracted from the environmental detection data that characterizes an external condition of a pipeline. The environmental characteristic may include a consistency vector and a mean vector. More descriptions regarding the environmental detection data may be found in FIG. 2 and the related descriptions thereof.

The consistency vector refers to a vector consisting of consistency of a plurality of indicators of the environmental detection data. In some embodiments, for each of the plurality of indicators, the smart gas pipeline network safety management platform 130 may determine, based on detection values of the indicator of the environmental detection data at a plurality of points among a set of second preset points, consistency of the indicator at the plurality of points among the set of the second preset points, and the consistency of the plurality of indicators forms the consistency vector.

The consistency of an indicator refers to a property of the indicator being consistent. The consistency of an indicator may be measured by determining a standard deviation of the indicator. For example, the environmental detection data includes indicator A, indicator B, indicator C . . . , and the consistency vector of the environmental detection data is represents as [standard deviation of indicator A, standard deviation of indicator B, standard deviation of indicator C . . . ]. The smart gas pipeline network safety management platform 130 may determine the standard deviation of indicator A at a plurality of points among a set of second preset points based on detection values of indicator A at the plurality of points among the set of second preset points, wherein the standard deviation may be used to characterize the consistency of the indicator of the environmental detection data.

The mean vector refers to a vector that includes mean values of the plurality of indicators of the environmental detection data. In some embodiments, for each of the plurality of indicators, the smart gas pipeline network safety management platform 130 may determine a mean for the indicator of the environmental detection data, and the means of the plurality of indicators form the mean vector. Continuing with the previous example, the environmental detection data includes indicator A, indicator B, indicator C . . . , and the mean vector may be represents as [mean value of indicator A, mean value of indicator B, mean value of indicator C . . . ].

In some embodiments, the smart gas pipeline network safety management platform 130 may construct the consistency vector and the mean vector by determining the consistency and the mean value of each of the plurality of indicators of the environmental detection data and combine the consistency vector and the mean vector to form the environmental characteristic.

Operation 320, comparing the mean vector in the environmental characteristic with standard environmental data to determine an abnormal value of the indicator.

The standard environmental data refers to manually preset environmental data. The standard environmental data includes standard indicator values of a plurality of indicators of the environmental detection data.

The abnormal value refers to a value of a difference between the mean vector and the standard indicator value.

In some embodiments, the smart gas pipeline network safety management platform 130 may determine the abnormal value based on the difference between the mean vector and the standard indicator value. For example, the abnormal value of an indicator may be calculated by equation (2):

$$S = \vert Q - t \vert \qquad ( 2 )$$

Wherein S denotes the abnormal value of the indicator, Q denotes the mean value of the indicator in the mean vector, and t denotes the standard indicator value of the indicator in the standard environmental data.

Operation 330, performing, based on the abnormal value of the indicator and a weight of the indicator, a weighted sum to determine a soil corrosion capacity.

In some embodiments, the smart gas pipeline network safety management platform 130 may determine the soil corrosion capacity through a weighted sum based on the abnormal value of each indicator and a weight corresponding to the indicator. For example, the soil corrosion capacity may be calculated as: soil corrosion capacity=abnormal value of the indicator A×weight A+abnormal value of the indicator B×weight B. The greater a difference between the environmental detection data and the standard environmental data, the greater the soil corrosion capacity.

In some embodiments, the consistency vector includes the consistency of the indicator of the environmental detection data, with the weight determined based on the consistency. More descriptions regarding the consistency vector may be found in operation 310 and the related descriptions thereof. The weight of each indicator in the environmental detection data is negatively correlated with the consistency of the indicator in the consistency vector of the environmental detection data.

Understandably, assuming that indicator A is a temperature of soil, lower consistency of the temperature of the soil (a larger standard deviation) signifies a larger difference/fluctuation in the temperatures of the soil corresponding to the plurality of points among the set of second preset points, potentially reducing a lifespan of the pipeline. Thus, the higher the weight of indicator A.

In some embodiments, the smart gas pipeline network safety management platform 130 may determine the weight of the indicator based on the consistency of the indicator of the environmental detection data by querying a second preset table. The second preset table may be established based on a historical correspondence between the consistency of the indicator of the environmental detection data and the weight of the indicator, wherein the lower the consistency of the indicator of the environmental detection data, the higher the weight of the indicator.

In some embodiments of the present disclosure, determining the weight of the indicator based on the consistency of the indicator allows for full consideration of an impact of an indicator with low consistency on the soil corrosion capacity, leading to a more reasonable determination of the soil corrosion capacity.

In some embodiments, the mean vector includes the mean of the indicator of the environmental detection data, the weight may be determined based on a change rate vector, and the change rate vector may be constructed based on the change rate of the mean of the indicator within a preset time period.

The change rate vector refers to a vector constructed based on maximum change rates of a plurality of indicators. The maximum change rate refers to a maximum value of a change rate of an indicator at a plurality of time points.

In some embodiments, the smart gas pipeline network safety management platform 130 may obtain a plurality of sets of environmental detection data collected at a plurality of time points within the preset time period, determine a mean vector of each set of the environmental detection data at the plurality of time points, respectively, and obtain a plurality of mean vectors at the plurality of time points. The smart gas pipeline network safety management platform 130 may determine a maximum change rate of each indicator at the plurality of time points based on the mean value of the indicator in the plurality of mean vectors at the plurality of time points as the change rate corresponding to the indicator.

In some embodiments, the smart gas pipeline network safety management platform 130 may determine the weight of the indicator by querying a third preset table based on the change rate of the indicator. The third preset table may be established based on a correspondence between the change rate of the indicator and the weight of the indicator, wherein the greater the change rate of the indicator, the higher the weight of the indicator.

In some embodiments of the present disclosure, the smart gas pipeline network safety management platform 130 determines the weight of the indicator based on the change rate vector, so that the influence of the indicator with a large change rate on the soil corrosion capacity can be fully taken into account, and the soil corrosion capacity can be determined more reasonably.

Operation 340, predicting, based on the soil corrosion capacity and a potential detection device parameter, the device corrosion degree.

The potential detection device parameter refers to a parameter related to an operation of a potential detection device. The potential detection device parameter may include a performance parameter and a maintenance parameter.

The performance parameter may be related to intrinsic performance of the potential detection device. For example, the performance parameter may include sensitivity, response time, stability, etc., of the potential detection device. The stability of the potential detection device refers to a degree of stability in detection readings of the potential detection device. The performance parameter may be obtained from a user manual of the potential detection device and a historical usage record.

The maintenance parameter refers to a parameter related to maintenance of the potential detection device. For example, the maintenance parameter may include a count of repairs of the potential detection device. The maintenance parameter may be obtained from a historical maintenance record of the potential detection device.

The potential detection device parameter may be characterized by a device performance level. For example, the more ideal the parameter reflected by the potential detection device parameter, the higher the device performance level.

In some embodiments, the smart gas pipeline network safety management platform 130 may determine the device performance level based on the potential device parameters via a fourth preset table. The fourth preset table may be constructed based on the potential device parameter and the device performance level, wherein the higher the sensitivity, and the shorter the response time, the higher the stability; the fewer the count of repairs in the maintenance parameter, the higher the device performance level.

In some embodiments, the smart gas pipeline network safety management platform 130 may determine the device corrosion degree based on a weighted sum of the soil corrosion capacity and the device performance level, wherein a weight may be preset by a technician.

In some embodiments of the present disclosure, determining the soil corrosion capacity based on the abnormal value and the weight of the indicator of the environmental detection data allows for a comprehensive consideration of an influence of various indicators on the soil corrosion capacity, thus the soil corrosion capacity can be reasonably determined.

In some embodiments, the smart gas pipeline network safety management platform 130 may determine a soil resistance characteristic based on the soil resistivity within a preset period and determine the resistance distribution based on the soil resistance characteristic, wherein the resistance distribution is a soil resistivity distribution map.

The soil resistance characteristic refers to characteristic vector that characterize mean, consistency, and stability of the soil resistivity. More descriptions regarding the soil resistivity may be found in FIG. 2 and the related descriptions thereof.

In some embodiments, the soil resistance characteristic includes a first resistance characteristic and a second resistance characteristic.

The first resistivity characteristic refers to the soil resistance characteristic of a first type of point. The first resistive characteristic may include a resistivity mean vector, a resistivity consistency vector, and a first stability vector.

The resistance mean vector refers to a vector consisting of mean resistivity values of a plurality of sets of first type of points.

In some embodiments, the smart gas pipeline network safety management platform 130 may determine a mean resistivity value for each of the plurality of sets of first type of points. For example, if a set of the first type of points corresponds to a set of soil resistivity values R1, R2, R3, R4, the mean resistivity value may be determined as: mean resistivity value=(R1+R2+R3+R4)/4. The smart gas pipeline network safety management platform 130 may construct the resistivity mean vector based on a plurality of mean resistivity values obtained from the plurality of sets of the first type of points.

The resistivity consistency vector refers to a vector consisting of resistivity consistency of the plurality of sets of the first type of points.

In some embodiments, the smart gas pipeline network safety management platform 130 may determine the resistivity consistency for each of the plurality of sets of the first type of points. For example, the smart gas pipeline network safety management platform 130 may determine a resistivity standard deviation based on the set of soil resistivity values R1, R2, R3, and R4 corresponding to the set of the first type of points, use the resistivity standard deviation to represent the resistivity consistency, and construct the resistivity consistency vector based on resistivity consistency obtained from the plurality of sets of the first type of points.

The first stability vector refers to a vector consisting of maximum change rates of mean resistivity values of the plurality of sets of the first type of points.

In some embodiments, the smart gas pipeline network safety management platform 130 may determine the resistivity stability vector based on a plurality of soil resistivities corresponding to a plurality of sets of the first type of points collected at a plurality of time points during a preset time period. For example, the smart gas pipeline network safety management platform 130 may determine a resistivity mean vector corresponding to each of the plurality of time points based on the plurality of soil resistivities corresponding to the plurality of sets of the first type of points collected at each of the plurality of time points, determine a maximum change rate of the resistivity mean vector corresponding to each set of the plurality of sets of the first type of points based on the resistivity mean vector corresponding to each of the plurality of time points, and form the resistivity stability vector based on the maximum change rates of the mean resistivity values of the plurality of sets of the first type of points.

The second resistance characteristic refers to the soil resistance characteristic of a second type of point. The second resistance characteristic includes a second stability vector.

The second resistivity stability vector is a vector consisting of maximum change rates of mean resistivity values of the second type of points.

In some embodiments, the smart gas pipeline network safety management platform 130 may determine, based on a plurality of soil resistivities corresponding to the second type of points at a plurality of time points in the preset time period, the maximum change rate of the soil resistivity at each of the second type of points, and form the second stability vector based on the maximum change rate of the soil resistivity at each of the second type of points.

More descriptions regarding the first type of point and the second type of point may be found in FIG. 2 and the related descriptions thereof.

The resistance distribution refers to a distribution of change in magnitude of soil resistivity, which may be represented, for example, by a soil resistivity distribution map.

The soil resistivity distribution map is a map used to represent a distribution of the soil resistivity. In some embodiments, the smart gas pipeline network safety management platform may obtain a pre-stored soil resistivity distribution map. The soil resistivity distribution map may include a node and an edge.

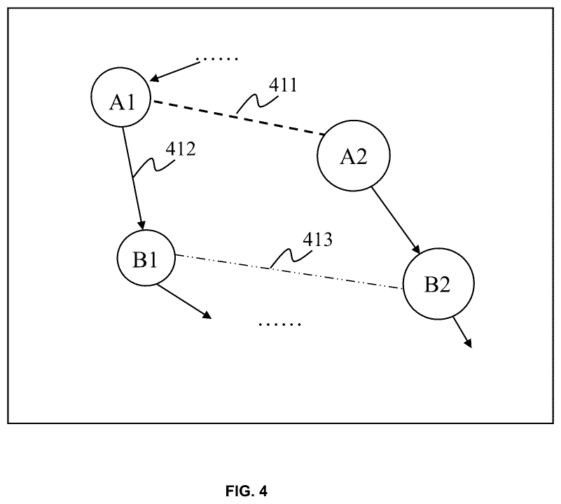

The node includes a first type of node and a second type of node. The first type of node refers to a region enclosed by each set of third preset points in the first type of points, and the second type of node refers to a region corresponding to each third preset point in a set of third preset points in the second type of points. As shown in FIG. 4, the node may include a first type of node A1, a first type of node A2, a second type of node B1, and a second type of node B2.

The node has a node characteristic. The node characteristic of the first type of node includes a resistivity mean value of the node, resistivity consistency, first resistivity stability, an area of a region in which the node is located, and an environment in which the node is located. The node characteristic of the second type of node includes a resistivity value of the node, second resistivity stability, and an environment in which the node is located. The resistivity value of the node of the node characteristic of the second type of node is obtained from the resistivity value of the node at a most recent moment.

When two nodes are adjacent to each other, the two nodes may be connected by an edge. The edge represents connectivity between the two nodes. The edge may include an edge between the first type of nodes, an edge between the second type of nodes, and an edge connecting the first type of nodes and the second type of the node. As shown in FIG. 4, edge 411 represents a connection relationship between a first type of node A1 and a first type of node A2, edge 412 represents a connection relationship between the first type of node A1 and a second type of node B1, and edge 413 represents a connection relationship between the second type of node B1 and a second type of node B2.

The edge has an edge characteristic. The edge characteristic may include a distance between nodes and an elevation difference between the nodes.

In some embodiments of the present disclosure, the smart gas pipeline network safety management platform 130 determines the soil resistance characteristic based on the soil resistivity and constructs the soil resistivity distribution map based on the soil resistance characteristic, which allows for a reasonable determination of the resistance distribution of soil, thereby improving the accuracy of a prediction model in predicting pipeline potential data and determining the cathode protection score more accurately.

FIG. 5 is a flowchart illustrating an exemplary process of issuing an early warning prompt according to some embodiments of the present disclosure. As shown in FIG. 5, process 500 is performed by the smart gas pipeline network safety management platform 130 and includes following operations.

Operation 510, predicting a credibility degree of pipeline potential data based on a device corrosion degree, a resistance distribution, and an IR drop distribution.

The credibility degree refers to an accuracy degree of the pipeline potential data.

In some embodiments, the smart gas pipeline network safety management platform 130 may predict the credibility degree of the pipeline potential data through various manners. For example, the smart gas pipeline network safety management platform 130 may predict the credibility degree of the pipeline potential data based on the device corrosion degree, the resistance distribution, and the IR drop distribution using a fifth preset table. The fifth preset table may be established based on a relationship between the device corrosion degree, the resistance distribution, the IR drop distribution, and the credibility degree of the pipeline potential data. The greater the device corrosion degree, a soil resistivity, and an IR drop, the lower the credibility degree of the pipeline potential data.

In some embodiments, the smart gas pipeline network safety management platform 130 may predict the credibility degree of the pipeline potential data based on the device corrosion degree, the resistance distribution, and the IR drop distribution through a prediction model.

In some embodiments, the prediction model is a machine learning model, such as a neural networks (NN) model, a graph neural networks (GNN) model, or the like.

In some embodiments, an input of the prediction model includes the device corrosion degree, the resistance distribution, and the IR drop distribution, and an output of the prediction model includes the credibility degree of the pipeline potential data. The resistance distribution is the soil resistivity distribution map shown in FIG. 4. More descriptions regarding the device corrosion degree and the IR drop distribution may be found in FIG. 2 and the related descriptions thereof.

In some embodiments, the prediction model may be obtained based on training samples with labels. The smart gas pipeline network safety management platform 130 may input a plurality of training samples with labels into an initial prediction model, construct a loss function based on the labels and results of the initial prediction model, and iteratively update an initial parameter of the prediction model based on the loss function. The model training is completed when the loss function of the initial prediction model satisfies a preset condition, and the trained prediction model is obtained. The preset condition may be that the loss function converges, a count of iterations reaches a threshold, or the like.

The training sample may include the device corrosion degree, the resistance distribution, and the IR drop distribution at sample first preset points. The label is the credibility degree of the pipeline potential data at the sample first preset points.

The training sample and the label may be obtained from historical data. For example, the first preset points are point A, point B, point C, and point D. The credibility degree of the pipeline potential data corresponding to points A, B, C, and D is denoted as a, b, c, and d, respectively. The training label is [a, b, c, d].

The smart gas pipeline network safety management platform 130 may obtain a history of an occurrence of abnormality in a pipeline corresponding to each of the first preset points A, B, C, and D. For a set of training samples, if abnormality occurs in the pipeline corresponding to at least one of the first preset points during a time period (e.g., one week) before or after a historical time of collecting the set of training samples, for example, assuming the abnormality occurs in point A and point C, then for the training label [a, b, c, d] corresponding to the set of training samples, training sub-labels a and c corresponding to the points A and C where abnormality occurs are values in a range of 0 and 1 (excluding 1, but may include 0), and training sub-labels corresponding to points without abnormality are 1. Continuing with the above example, the smart gas pipeline network safety management platform 130 may evaluate, based on historical experience, a severity of a type of the abnormality at points A and C to be 0.3 and 0.6, respectively, and that of point B and point D to be normal. The training label is [0.3, 1, 0.6, 1].

Values of training sub-labels corresponding to abnormal points are determined based on the severity of the type of the abnormality. For example, the more severe the type of the abnormality is, the closer the label is to 0.

When the credibility degree of the detection data of a preset point is lower, the soil resistivity is higher, and the pipeline IR drop is higher, the pipeline potential data detected is more unreliable, and it is necessary to exclude the pipeline potential data in the subsequent evaluation of the cathodic protection effect. For the credibility degree of each of pipeline potential measurement results of a preset point, the smart gas pipeline network safety management platform 130 may select a pipeline potential measurement result that has a high credibility degree to carry out the assessment of the credibility degree of the pipeline potential data. In some embodiments of the present disclosure, the smart gas pipeline network safety management platform 130 determines the credibility degree of the pipeline potential data based on the device corrosion degree, the resistance distribution, and the IR drop distribution through the prediction model, which can effectively improve the accuracy of the credibility degree of the pipeline potential data.

In 520, determining, based on the credibility degree, a target measurement result.

The target measurement result refers to a result that the credibility degree of the pipeline potential data exceeds ta credibility degree threshold.

In some embodiments, the smart gas pipeline network safety management platform 130 may compare the credibility degree of the pipeline potential data with the credibility degree threshold, and determine the pipeline potential data with the credibility degree greater than the credibility degree threshold as the target measurement result. The credibility degree threshold may be preset artificially.

In 530, determining, based on the target measurement result, a cathode protection score.

The cathode protection score is a parameter used to measure an effectiveness of cathodic protection.

In some embodiments, the smart gas pipeline network safety management platform 130 may determine a difference between each target measurement result and a preset standard potential, perform a weighted sum on the difference between each target measurement result and the preset standard potential to obtain a combined difference, and designate the combined difference as the cathode protection score. A weight may be manually preset based on historical experience. The preset standard potential is a potential when the cathodic protection effect meets requirements.

In 540, in response to determining that the cathode protection score meets a preset scoring condition, issuing the early warning prompt.

The preset scoring condition refers to a condition when the cathode protection score is below a scoring threshold.

In some embodiments, the scoring threshold is a dynamic threshold and may be determined based on an average credibility degree of the pipeline potential data.

The average credibility degree is an average of the credibility degree of the pipeline potential data. For example, for a plurality of first preset points A, B, C, and D, the corresponding measurement results are U1, U2, U3, and U4, respectively, and the credibility degree of each measurement result is P1, P2, P3, and P4, respectively, then the average credibility degree may be determined as (P1+P2+P3+P4)/4.

In some embodiments, the smart gas pipeline network safety management platform 130 may determine the scoring threshold based on the average credibility degree via a fifth preset table. The fifth preset table is established based on the average credibility degree and the scoring threshold. The larger the average credibility degree, the smaller the scoring threshold.

In some embodiments of the present disclosure, determining the scoring threshold based on the average credibility degree of the measurement result allows for a more reasonable determination of the preset scoring, thereby facilitating the assessment of the effectiveness of cathodic protection.

In some embodiments, in response to determining that the cathode protection score is lower than the scoring threshold, the smart gas pipeline network safety management platform 130 may issue the early warning prompt to the smart gas pipeline network maintenance engineering object sub-platform.

In some embodiments of the present disclosure, based on the credibility degree, the target measurement result may be determined; based on the target measurement result, the cathode protection score may be determined, thereby scientifically evaluate the cathodic protection effect on the pipeline and setting an appropriate preset scoring condition. In case of insufficient cathodic protection effect on the pipeline, a timely early warning prompt may be issued to remind maintenance personnel to conduct inspections and ensure the normal operation of the gas pipeline.

Some embodiments of the present disclosure provide a non-transitory computer-readable storage medium storing one or more sets of computer instructions, and when a computer reads the one or more sets of computer instructions in the storage medium, the computer executes the method for intelligent detection of cathodic protection in the smart gas pipeline as described above.

The basic concepts have been described above, and it is apparent that to a person skilled in the art, the above detailed disclosure is intended as an example only and does not constitute a limitation of the present disclosure. Although not expressly stated herein, various modifications, improvements, and amendments may be made to the present disclosure by those skilled in the art. Such modifications, improvements, and amendments are suggested in the present disclosure, so such modifications, improvements, and amendments remain within the spirit and scope of the exemplary embodiments of the present disclosure.

Also, the present disclosure uses specific words to describe the embodiments of the present disclosure. For example, “an embodiment,” “one embodiment,” and/or “some embodiments” are meant to refer to a certain feature, structure, or characteristic associated with at least one embodiment of the present disclosure. Accordingly, it should be emphasized and noted that “an embodiment” or “one embodiment” or “an alternative embodiment” mentioned two or more times in different places in the present disclosure do not necessarily refer to the same embodiment. Furthermore, certain features, structures, or characteristics in one or more embodiments of the present disclosure may be suitably combined.

Furthermore, unless expressly stated in the claims, the order of processing elements and sequences, the use of numerical letters, or the use of other names described herein are not intended to limit the order of the processes and methods of the present disclosure. Although a number of embodiments of the present disclosure currently considered useful are discussed in the above disclosure by way of various examples, it should be understood that such details serve illustrative purposes only, and that additional claims are not limited to the disclosed embodiments; rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the present disclosure, and thus aid in the understanding of one or more embodiments of the present disclosure, the preceding description of embodiments of the present disclosure sometimes combines multiple features into a single embodiment, accompanying drawings, or description thereof. However, this way of disclosure does not imply that the subject matter of the present disclosure requires more features than those mentioned in the claims. Rather, claimed subject matter may lie in less than all features of a single foregoing disclosed embodiment.

In some embodiments, numeric values describing the composition and quantity of attributes are used in the description. It should be understood that such numeric values used for describing embodiments may be modified with qualifying terms such as “about,” “approximately,” or “generally.” Unless otherwise stated, “about,” “approximately,” or “generally” indicates that a variation of +20% is permitted in the described numbers. Accordingly, in some embodiments, the numerical parameters used in the disclosure and claims are approximations, which may change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

Finally, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A method for intelligent detection of cathodic protection in a smart gas pipeline, wherein the method is executed by a smart gas pipeline network safety management platform of an Internet of Things (IoT) system for intelligent detection of cathodic protection in the smart gas pipeline, and the method comprises:
obtaining pipeline potential data of a first preset point;
obtaining environmental detection data of a second preset point;
determining, based on the environmental detection data, a device corrosion degree of the first preset point, the second preset point being determined based on the first preset point;
obtaining a soil resistivity of a third preset point;
determining, based on the soil resistivity, a resistance distribution, the third preset point being determined based on the first preset point;
obtaining pipeline data and cathodic protection data;
determining, based on the pipeline data and the cathodic protection data, an IR drop distribution;
determining a cathodic protection effect based on the device corrosion degree, the resistance distribution, the IR drop distribution, and the pipeline potential data; and
in response to determining that the cathodic protection effect does not meet a preset condition, issuing an early warning prompt.

2. The method of claim 1, wherein an indicator corresponding to the environmental detection data includes one or more of a temperature, a humidity, a pH value, an oxygen content, a moisture content, a sulfide content, and a chloride content of soil, and the determining, based on the environmental detection data, a device corrosion degree of the first preset point includes:
determining, based on the environmental detection data, an environmental characteristic, wherein the environmental characteristic includes a consistency vector and a mean vector;
comparing the mean vector in the environmental characteristic with standard environmental data to determine an abnormal value of the indicator;
performing, based on the abnormal value of the indicator and a weight of the indicator, a weighted sum to determine a soil corrosion capacity; and
predicting, based on the soil corrosion capacity and a potential detection device parameter, the device corrosion degree.

3. The method of claim 2, wherein the consistency vector includes consistency of the indicator of the environmental detection data, and the weight is determined based on the consistency.

4. The method of claim 2, wherein the mean vector includes a mean of the indicator of the environmental detection data, the weight is determined based on a change rate vector, and the change rate vector is constructed based on the mean of the indicator within a preset period.

5. The method of claim 1, wherein the determining, based on the soil resistivity, a resistance distribution includes:
determining a soil resistance characteristic based on a soil resistivity within a preset period; and
determining the resistance distribution based on the soil resistance characteristic, the resistance distribution being a soil resistivity distribution map.

6. The method of claim 1, wherein the determining a cathodic protection effect based on the device corrosion degree, the resistance distribution, the IR drop distribution, and the pipeline potential data, and in response to determining that the cathodic protection effect does not meet a preset condition, issuing an early warning prompt includes:
predicting a credibility degree of the pipeline potential data based on the device corrosion degree, the resistance distribution, and the IR drop distribution;
determining, based on the credibility degree, a target measurement result;
determining, based on the target measurement result, a cathode protection score; and
in response to determining that the cathode protection score meets a preset scoring condition, issuing the early warning prompt.

7. The method of claim 6, wherein the predicting a credibility degree of the pipeline potential data based on the device corrosion degree, the resistance distribution, and the IR drop distribution includes:
predicting, based on the device corrosion degree, the resistance distribution, and the IR drop distribution, the credibility degree of the pipeline potential data through a prediction model, the prediction model being a machine learning model.

8. The method of claim 6, wherein the preset scoring condition includes the cathode protection score being below a scoring threshold, the scoring threshold is a dynamic threshold, and the scoring threshold is determined based on an average credibility degree of the pipeline potential data.

9. An Internet of Things (IoT) system for intelligent detection of cathodic protection in a smart gas pipeline, wherein the system includes a smart gas pipeline network safety management platform, and the smart gas pipeline network safety management platform is configured to:
obtain pipeline potential data of a first preset point;
obtain environmental detection data of a second preset point;
determine, based on the environmental detection data, a device corrosion degree of the first preset point, the second preset point being determined based on the first preset point;
obtain a soil resistivity of a third preset point;
determine, based on the soil resistivity, a resistance distribution, the third preset point being determined based on the first preset point;
obtain pipeline data and cathodic protection data;
determine, based on the pipeline data and the cathodic protection data, an IR drop distribution;
determine a cathodic protection effect based on the device corrosion degree, the resistance distribution, the IR drop distribution, and the pipeline potential data; and
in response to determining that the cathodic protection effect does not meet a preset condition, issue an early warning prompt.

10. The IoT system of claim 9, wherein the smart gas pipeline network safety management platform includes a smart gas pipeline network risk assessment management sub-platform and a smart gas data center, and the IoT system further includes a smart gas pipeline sensing network platform and a smart gas pipeline network object platform;
the smart gas pipeline network object platform is configured to obtain and transmit the pipeline potential data, the environmental detection data, and the soil resistivity to the smart gas data center via the smart gas pipeline sensing network platform;
the smart gas pipeline network risk assessment management sub-platform is configured to determine the cathodic protection effect based on the smart gas data center and issue the early warning prompt; and
the smart gas pipeline network safety management platform is configured to transmit the early warning prompt to the smart gas pipeline network object platform via the smart gas pipeline sensing network platform.

11. The IoT system of claim 9, wherein an indicator corresponding to the environmental detection data includes one or more of a temperature, a humidity, a pH value, an oxygen content, a moisture content, a sulfide content, and a chloride content of soil, and the smart gas pipeline network safety management platform is further configured to:
determine, based on the environmental detection data, an environmental characteristic, wherein the environmental characteristic includes a consistency vector and a mean vector;
compare the mean vector in the environmental characteristic with standard environmental data to determine an abnormal value of the indicator;
perform, based on the abnormal value of the indicator and a weight of the indicator, a weighted sum to determine a soil corrosion capacity; and
predict, based on the soil corrosion capacity and a potential detection device parameter, the device corrosion degree.

12. The IoT system of claim 11, wherein the consistency vector includes consistency of the indicator of the environmental detection data, and the weight is determined based on the consistency.

13. The IoT system of claim 11, wherein the mean vector includes a mean of the indicator of the environmental detection data, the weight is determined based on a change rate vector, and the change rate vector is constructed based on the mean of the indicator within a preset period.

14. The IoT system of claim 9, wherein the smart gas pipeline network safety management platform is further configured to:
determine a soil resistance characteristic based on a soil resistivity within a preset period; and
determine the resistance distribution based on the soil resistance characteristic, the resistance distribution being a soil resistivity distribution map.

15. The IoT system of claim 9, wherein the smart gas pipeline network safety management platform is further configured to:
predict a credibility degree of the pipeline potential data based on the device corrosion degree, the resistance distribution, and the IR drop distribution;
determine, based on the credibility degree, a target measurement result;
determine, based on the target measurement result, a cathode protection score; and
in response to determining that the cathode protection score meets a preset scoring condition, issue the early warning prompt.

16. The IoT system of claim 15, wherein the smart gas pipeline network safety management platform is further configured to:
predict, based on the device corrosion degree, the resistance distribution, and the IR drop distribution, the credibility degree of the pipeline potential data through a prediction model, the prediction model being a machine learning model.

17. The IoT system of claim 15, wherein the preset scoring condition includes the cathode protection score being lower than a scoring threshold, the scoring threshold is a dynamic threshold, and the scoring threshold is determined based on an average credibility degree of the pipeline potential data.

18. A non-transitory computer-readable storage medium, wherein the storage medium stores one or more sets of computer instructions, and when a computer reads the one or more sets of computer instructions in the storage medium, the computer executes a method for intelligent detection of cathodic protection in a smart gas pipeline, wherein the method is executed by a smart gas pipeline network safety management platform of an Internet of Things (IoT) system for intelligent detection of cathodic protection in the smart gas pipeline, and the method comprises:
obtaining pipeline potential data of a first preset point;
obtaining environmental detection data of a second preset point;
determining, based on the environmental detection data, a device corrosion degree of the first preset point, the second preset point being determined based on the first preset point;
obtaining a soil resistivity of a third preset point;
determining, based on the soil resistivity, a resistance distribution, the third preset point being determined based on the first preset point;
obtaining pipeline data and cathodic protection data;
determining, based on the pipeline data and the cathodic protection data, an IR drop distribution;
determining a cathodic protection effect based on the device corrosion degree, the resistance distribution, the IR drop distribution, and the pipeline potential data; and
in response to determining that the cathodic protection effect does not meet a preset condition, issuing an early warning prompt.
